(19) United States
(12) Patent Application Publication
(10) Pub. No.: US 2008/0252707 A1
(43) Pub. Date: Oct. 16, 2008

(54) Liquid supply apparatus, liquid supply method and image forming apparatus

(75) Inventor: Naoki Kusunoki, Kanagawa-ken (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/892,245

(22) Filed: Aug. 21, 2007

(30) Foreign Application Priority Data
Sep. 4, 2006 (JP) 2006-239332

(51) Int. Cl. B41J 2/19

(52) U.S. Cl. 347/92

(57) ABSTRACT

The liquid supply apparatus includes: a liquid ejection head which includes: a plurality of bubble generating chambers in which liquid is heated to generate ejection bubbles causing the liquid to be ejected through ejection ports; a common flow channel connected to the plurality of bubble generating chambers and storing the liquid to be supplied to the plurality of bubble generating chambers; and bubble restricting members restricting passage of bubbles between the common flow channel and the plurality of bubble generating chambers; a liquid storage unit which is connected to the common flow channel and which stores the liquid to be supplied to the common flow channel; a first suctioning device which caps and suctions an ejection face of the liquid ejection head on which the ejection ports are arranged; and a pressure reduction device which reduces pressure of the liquid storage unit.

### BACKGROUND OF THE INVENTION

1. Field of the Invention

The present invention relates to a liquid supply apparatus, a liquid supply method and an image forming apparatus, and more particularly to a liquid supply apparatus, a liquid supply method and an image forming apparatus whereby wasteful consumption of liquid can be minimized and bubbles can be removed efficiently.

2. Description of the Related Art

An inkjet recording apparatus has been known which performs recording by ejecting ink from a recording head on a recording medium, and such apparatus has been widely used because of its excellent low-noise operation, low running costs, and capability for recording high-quality images onto recording media of various different types. In particular, inkjet recording apparatuses using a thermal method which ejects ink by means of the thermal energy created by a heating element are beneficial in terms of achieving a high density of the nozzle pitch in the head structure, compared to apparatuses based on a piezoelectric method which ejects ink by means of the displacement of a piezoelectric element. The inkjet recording apparatuses of thermal method type have made progress in achieving high-density recording.

In a recording head used in the inkjet recording apparatus, the incorporation of bubbles (e.g., air bubbles) into the ink inside the head can be a cause of ejection abnormalities, since the incorporation of the bubbles retards the normal ejection of ink droplets from the ink ejection ports (nozzles). Hence, an operation is generally carried out in which after an initial ink filling operation for instance, the ink inside the head is suctioned from the nozzles or ejected from the nozzles by preliminary ejection (purging) together with the bubbles that have entered into the head, thereby removing the bubbles. However, this kind of process is problematic in that all of the ink inside the head is wasted.

In Japanese Patent Application Publication No. 2002-103645, a bubble trapping section is provided in the common flow channel (common liquid chamber) of a recording head. The bubble trapping section is a portion of the upper wall of the common liquid chamber that is raised compared to the other portions of the common liquid chamber. The incorporation of the bubbles (air bubbles) into bubble generating chambers is prevented by causing the bubbles (air bubbles) inside the common flow channel to collect at the air bubble trapping section.

However, in Japanese Patent Application Publication No. 2002-103645, the air bubbles are not removed completely from inside the recording head, but rather are simply collected at the bubble trapping section, and the air bubbles present in the air bubble trapping section may be incorporated into the bubble generating chambers together with the ink inside the common flow channel. Consequently, there is a possibility that stable ejection will be impaired due to the incorporation of the bubble (air bubble) into the bubble generating chambers.

### SUMMARY OF THE INVENTION

The present invention has been contrived in view of these circumstances, an object thereof being to provide a liquid supply apparatus, a liquid supply method and an image forming apparatus, whereby wasteful consumption of liquid can be minimized and bubbles can be removed efficiently.

In order to attain the aforementioned object, the present invention is directed to a liquid supply apparatus, including: a liquid ejection head which includes: a plurality of bubble generating chambers in which liquid is heated to generate ejection bubbles causing the liquid to be ejected through ejection ports; a common flow channel connected to the plurality of bubble generating chambers and storing the liquid to be supplied to the plurality of bubble generating chambers; and bubble restricting members restricting passage of bubbles between the common flow channel and the plurality of bubble generating chambers; a liquid storage unit which is connected to the common flow channel and which stores the liquid to be supplied to the common flow channel; a first suctioning device which caps and suctions an ejection face of the liquid ejection head on which the ejection ports are arranged; and a pressure reduction device which reduces pressure of the liquid storage unit.

According to the present invention, since the bubble restricting members restricts the passage of the bubbles between the bubble generating chambers and the common flow channel (the bubble restricting members are provided between the bubble generating chambers and the common flow channel), then large bubbles are likely to be present in the liquid storage unit or the common flow channel whereas small bubbles are likely to be present in the bubble generating chambers. Moreover, the liquid inside the liquid storage unit and the common flow channel can be deaerated by reducing the pressure of the liquid storage unit, and the large bubbles present in the liquid storage unit or the common flow channel can thereby be removed without creating wasteful consumption of liquid. On the other hand, by expelling the liquid inside the bubble generating chambers by means of preliminary ejection or suctioning, it is possible to remove the small bubbles present in the bubble generating chambers. Consequently, it is possible to remove bubbles efficiently while minimizing wasteful consumption of liquid.

Preferably, wherein the pressure reduction device includes: an air connection channel which is connected through a gas-liquid separating member to the liquid storage unit, the gas-separating member inhibiting passage of the liquid while allowing passage of gas; and a second suctioning device which is connected to the air connection channel and suctions gas in the air connection channel.

According to this aspect of the present invention, it is possible to deaerate the liquid in the liquid storage unit and the common flow channel, by reducing the pressure of the air connection channel which connects to the liquid storage unit via the gas-liquid separating member, by means of the suctioning device. Furthermore, it is also possible to prevent the reverse flow of liquid from the liquid storage unit to the air connection channel, by means of the gas-liquid separating member.

Preferably, an interval between the bubble restricting members is less than a diameter of the ejection ports.

According to this aspect of the present invention, it is possible to remove the small bubbles present in the bubble generating chambers, efficiently.

In order to attain the aforementioned object, the present invention is also directed to a liquid supply method for a liquid ejection apparatus which includes: a liquid ejection head having a plurality of bubble generating chambers in which liquid is heated to generate ejection bubbles causing the liquid to be ejected through ejection ports, a common flow channel which is connected to the plurality of bubble generating chambers and which stores the liquid to be supplied to the plurality of bubble generating chambers, and bubble restricting members restricting passage of bubbles between the common flow channel and the plurality of bubble generating chambers; a liquid storage unit which is connected to the common flow channel and which stores the liquid to be supplied to the common flow channel; a suctioning device which caps and suctions an ejection face of the liquid ejection head on which the ejection ports are arranged; and a pressure reduction device which reduces pressure of the liquid storage unit, the liquid supply method including the steps of: capping and suctioning the ejection face of the liquid ejection head; supplying the liquid to the liquid storage unit; reducing the pressure of the liquid storage unit; and performing preliminary ejection of the liquid in the bubble generating chambers.

Further, in order to attain the aforementioned object, the present invention is also directed to an image forming apparatus including the liquid supply apparatus according to any one of the above-described aspects.

According to the present invention, since the bubble restricting members restricts the passage of the bubbles between the bubble generating chambers and the common flow channel, then large bubbles are likely to be present in the liquid storage unit or the common flow channel whereas small bubbles are likely to be present in the bubble generating chambers. Moreover, the liquid inside the liquid storage unit and the common flow channel can be deaerated by reducing the pressure of the liquid storage unit, and the large bubbles present in the liquid storage unit or the common flow channel can be removed without creating a large amount of wastefully consumed liquid. On the other hand, by expelling the liquid inside the bubble generating chambers by means of preliminary ejection or suctioning, it is possible to remove the small bubbles present in the bubble generating chambers. Consequently, it is possible to remove bubbles efficiently while minimizing wasteful consumption of liquid.

### BRIEF DESCRIPTION OF THE DRAWINGS

The nature of this invention, as well as other objects and benefits thereof, will be explained in the following with reference to the accompanying drawings, in which like reference characters designate the same or similar parts throughout the figures and wherein:

FIG. 1 is a general schematic drawing of an inkjet recording apparatus according to an embodiment of the present invention;

FIG. 2 is a general schematic drawing showing the composition of the peripheral area of a print unit of the inkjet recording apparatus;

FIGS. 3A to 3C are compositional diagrams of a recording head according to an embodiment of the present invention;

FIG. 4 is a schematic drawing showing the composition of an ink supply system in the inkjet recording apparatus; and

FIG. 5 is a flow diagram showing a bubble removal method during initial filling.

### DETAILED DESCRIPTION OF THE PREFERRED EMBODIMENTS

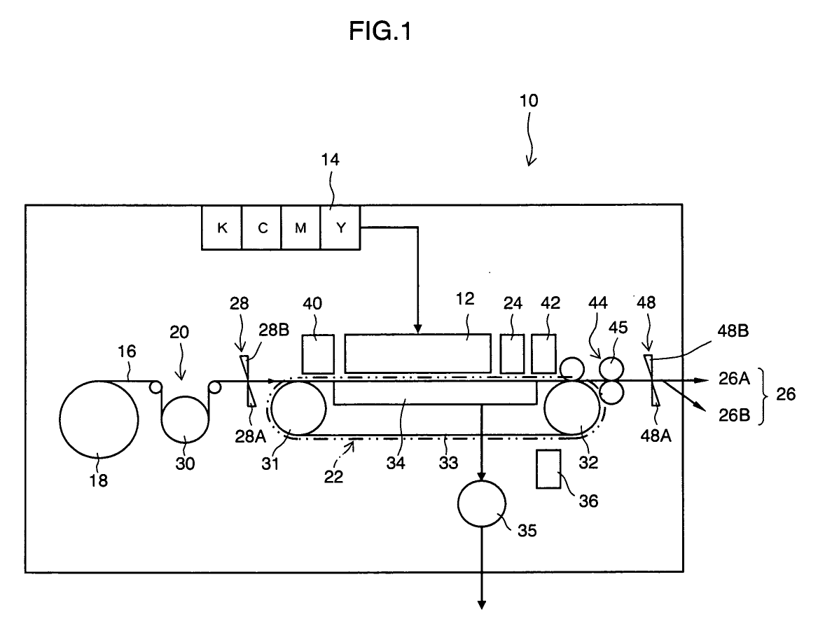

Firstly, an inkjet recording apparatus which is one embodiment of the image forming apparatus according to the present invention will be described. FIG. 1 is a general schematic drawing of an inkjet recording apparatus according to an embodiment of the present invention. As shown in FIG. 1, the inkjet recording apparatus 10 according to the present embodiment includes: a print unit 12 having a plurality of recording heads (liquid ejection heads) provided for respective ink colors of black (K), cyan (C), magenta (M), and yellow (Y); an ink storing and loading unit 14 for storing inks to be supplied to the respective recording heads; a paper supply unit 18 for supplying recording paper 16; a decurling unit 20 for removing curl in the recording paper 16; a suction belt conveyance unit 22, disposed facing the nozzle face (ink ejection face) of the print unit 12, for conveying the recording paper 16 while keeping the recording paper 16 flat; a print determination unit 24 for reading the printed result produced by the print unit 12; and a paper output unit 26 for outputting printed recording paper (printed matter) to the exterior.

In FIG. 1, a magazine for rolled paper (continuous paper) is shown as an example of the paper supply unit 18; however, more magazines with paper differences such as paper width and quality may be jointly provided. Moreover, papers may be supplied with cassettes that contain cut papers loaded in layers and that are used jointly or in lieu of the magazine for rolled paper.

In the case of a configuration in which roll paper is used, a cutter 28 is provided as shown in FIG. 1, and the roll paper is cut to a desired size by the cutter 28. The cutter 28 has a stationary blade 28A, whose length is not less than the width of the conveyor pathway of the recording paper 16, and a round blade 28B, which moves along the stationary blade 28A. The stationary blade 28A is disposed on the reverse side of the printed surface of the recording paper 16, and the round blade 28B is disposed on the printed surface side across the conveyance path. When cut paper is used, the cutter 28 is not required.

In the case of a configuration in which a plurality of types of recording paper can be used, it is preferable that an information recording medium such as a bar code and a wireless tag containing information about the type of paper is attached to the magazine, and by reading the information contained in the information recording medium with a predetermined reading device, the type of paper to be used is automatically determined, and ink-droplet ejection is controlled so that the ink-droplets are ejected in an appropriate manner in accordance with the type of paper.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite to the curl direction in the magazine. At this time, the heating temperature is preferably controlled in such a manner that the recording paper 16 has a curl in which the surface on which the print is to be made is slightly rounded in the outward direction.

The decurled and cut recording paper 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the printing unit 12 forms a plane.

The belt 33 has a width that is greater than the width of the recording paper 16, and a plurality of suction apertures (not shown) are formed on the belt surface. A suction chamber 34 is disposed in a position facing the sensor surface of the print determination unit 24 and the nozzle face of the printing unit 12 on the interior side of the belt 33, which is set around the rollers 31 and 32, as shown in FIG. 1. The suction chamber 34 provides suction with a fan 35 to generate a negative pressure, and the recording paper 16 on the belt 33 is held by suction.

The belt 33 is driven in the clockwise direction in FIG. 1 by the motive force of a motor (not shown in Figures) being transmitted to at least one of the rollers 31 and 32, which the belt 33 is set around, and the recording paper 16 held on the belt 33 is conveyed in the paper conveyance direction (sub-scanning direction; from left to right in FIG. 1).

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not shown, embodiments thereof include a configuration in which the belt 33 is nipped with cleaning rollers such as a brush roller and a water absorbent roller, an air blow configuration in which clean air is blown onto the belt 33, or a combination of these. In the case of the configuration in which the belt 33 is nipped with the cleaning rollers, it is preferable to make the line velocity of the cleaning rollers different than that of the belt 33 to improve the cleaning effect.

The inkjet recording apparatus 10 may adopt a roller nip conveyance mechanism, instead of the suction belt conveyance unit 22. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 40 is disposed on the upstream side of the printing unit 12 in the conveyance pathway formed by the suction belt conveyance unit 22. The heating fan 40 blows heated air onto the recording paper 16 to heat the recording paper 16 immediately before printing so that the ink deposited on the recording paper 16 dries more easily.

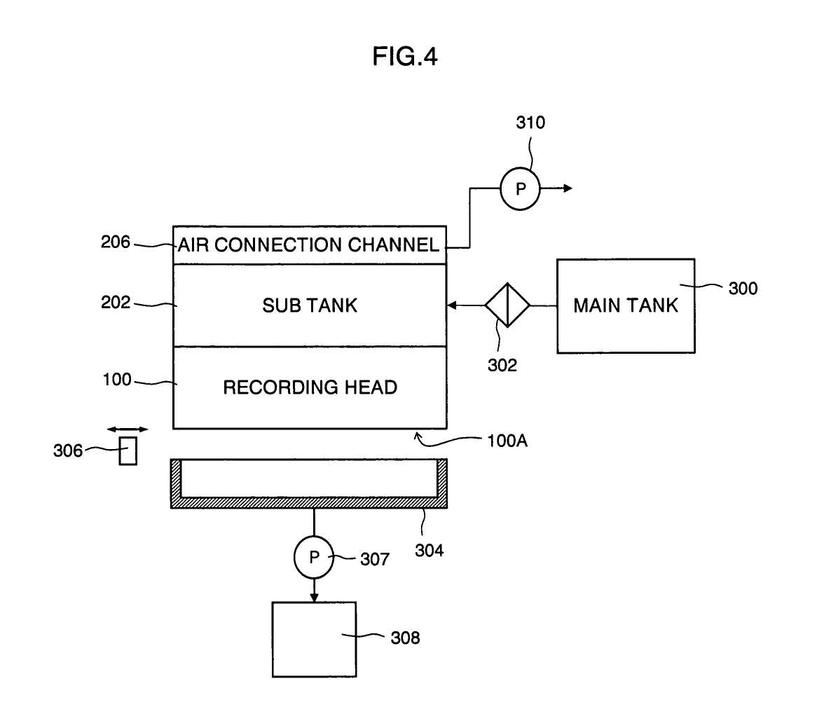

The ink storing and loading unit 14 has tanks (main tanks) which store inks of the colors corresponding to the respective recording heads of the print unit 12. For each color, ink is supplied from a main tank 300 to a sub tank 202 (see FIG. 4). Moreover, the ink storing and loading unit 14 also includes a notifying device (display device, alarm generating device, or the like) for generating a notification if the remaining amount of ink has become low, as well as having a mechanism for preventing incorrect loading of ink of the wrong color.

The print determination unit 24 has an image sensor (line sensor and the like) for capturing an image of the ink-droplet deposition result of the printing unit 12, and functions as a device to check for ejection defects such as clogs of the nozzles in the printing unit 12 from the ink-droplet deposition results evaluated by the image sensor.

The print determination unit 24 according to the present embodiment is configured with a line sensor having rows of photoelectric transducing elements with a width that is greater than the image recording width of the recording head 16. This line sensor has a color separation line CCD sensor including a red (R) sensor row composed of photoelectric transducing elements (pixels) arranged in a line provided with an R filter, a green (G) sensor row with a G filter, and a blue (B) sensor row with a B filter. Instead of a line sensor, it is possible to use an area sensor composed of photoelectric transducing elements which are arranged two-dimensionally.

The print determination unit 24 reads a test pattern image printed by the recording head for the respective colors, and the ejection of each recording head is determined. The ejection determination includes the presence of the ejection, measurement of the dot size, and measurement of the dot deposition position.

A post-drying unit 42 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming into contact with ozone and other substances that cause dye molecules to break down, and has the effect of increasing the durability of the print.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathways in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B. Although not shown in FIG. 1, the paper output unit 26A for the target prints is provided with a sorter for collecting prints according to print orders.

Although a configuration with the four standard colors, K, C, M and Y, is described in the present embodiment, the combinations of the ink colors and the number of colors are not limited to these, and light and/or dark inks can be added as required. For example, a configuration is possible in which recording heads for ejecting light-colored inks such as light cyan and light magenta are added.

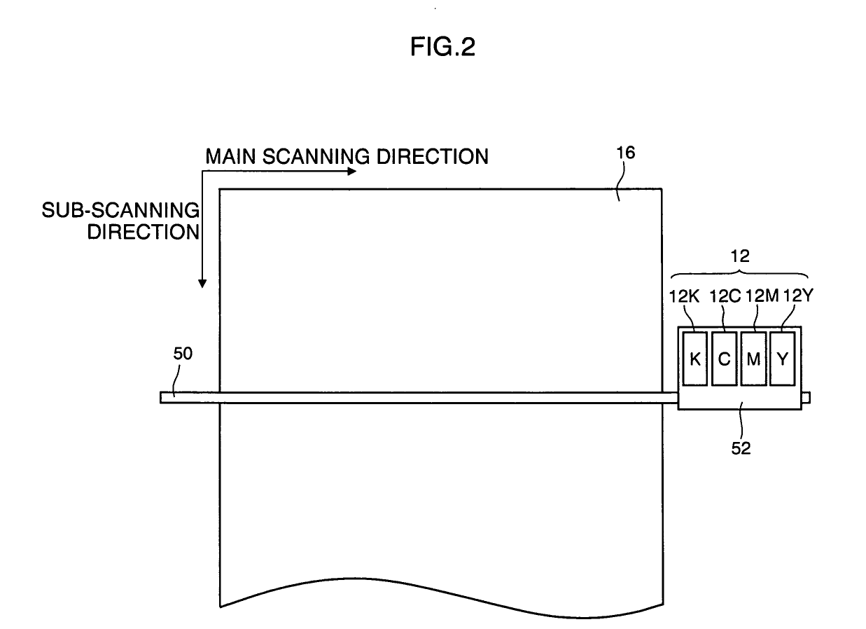

FIG. 2 is a principal plan diagram showing the periphery of the print unit in the inkjet recording apparatus 10. The inkjet recording apparatus 10 includes a carriage 52 which is configured to move reciprocally in the breadthways direction of the recording paper 16 (the main scanning direction) while being guided by a guide rail 50. Recording heads 12K, 12C, 12M and 12Y corresponding to the respective inks of the colors of black (K), cyan (C), magenta (M) and yellow (Y) are mounted on the carriage 52. The recording heads 12K, 12C, 12M and 12Y include heaters forming heat generating elements, and ink droplets are ejected from the ink ejection ports (nozzles) by means of the thermal energy generated by heat generating elements. In other words, the ink is heated by the heaters to generate ejection bubbles, and the ink is thereby ejected from the ink ejection ports in the form of droplets, by means of the ejection bubbles. The inkjet recording apparatus 10 ejects ink droplets of the respective colored inks from the corresponding recording heads 12K, 12C, 12M and 12Y, while conveying the recording paper 16 in the breadthways direction (paper conveyance direction) and moving the carriage 52, together with the recording heads 12K, 12C, 12M and 12Y, back and forth reciprocally in the main scanning direction. A desired image is thereby recorded onto the recording paper 16.

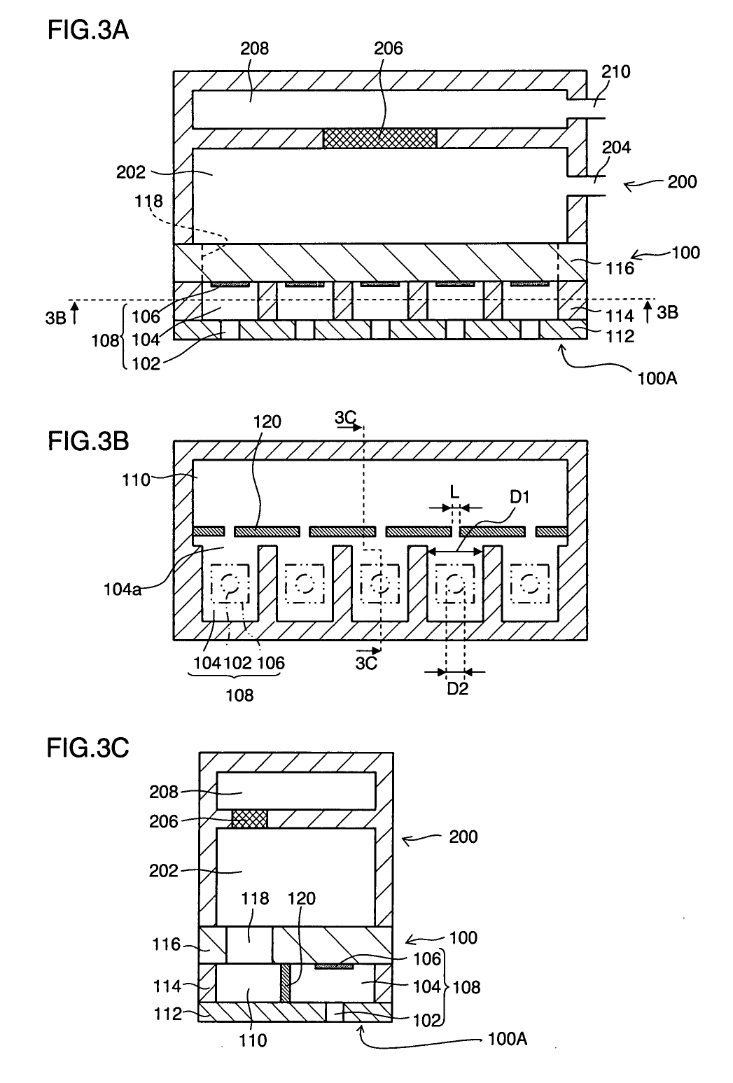

These recording heads 12K, 12C, 12M and 12Y are respectively formed integrally with the sub tanks (not shown in FIG. 2 and indicated by reference numeral 202 in FIGS. 3A and 3C), and during a recording operation, the ink stored in the sub tank is supplied in accordance with the consumption of ink by the recording head. Furthermore, if the remaining amount of ink inside the sub tank becomes equal to or less than a prescribed amount, as the recording operation advances, then the carriage 52 is moved to a prescribed standby position (maintenance position) such as that shown in FIG. 2. In the standby position, ink refilling is carried out from the main tank (not shown in FIG. 2, and indicated by reference numeral 300 in FIG. 4), and after filling a sufficient amount of ink into the sub tank, the recording operation is restarted.

Next, the composition of the recording heads 12K, 12C, 12M and 12Y will be described. The heads 12K, 12C, 12M and 12Y corresponding to the respective colors each have the same structure, and hereinafter, the reference numeral 100 is used to designate a representative example of the heads. FIGS. 3A to 3C are general schematic drawings of a recording head 100 (the recording heads 12K, 12C, 12M and 12Y corresponding to the respective colors shown in FIG. 2), wherein FIG. 3A is a cross-sectional diagram of a cross-section perpendicular to the nozzle face 100A, FIG. 3B is a cross-sectional diagram along line 3B-3B in FIG. 3A, and FIG. 3C is a cross-sectional diagram along line 3C-3C in FIG. 3B.

As shown in FIGS. 3A to 3C, in the recording head 100, ejection elements 108, each including a nozzle 102, a bubble generating chamber 104 and a heater 106, are arranged in one row, and furthermore, a common flow channel 110 is provided in parallel with the row of ejection elements. This recording head 100 has a structure in which a nozzle plate 112, a first substrate 114 and a second substrate 116 are bonded together successively. Here, the second substrate 116 may be constituted of a sheet of silicon substrate, for example.

The bubble generating chambers 104 which are connected respectively to the nozzles 102 are the regions which are filled with ink that is to be ejected from the nozzles 102, and the bubble generating chambers 104 are demarcated by means of the first substrate 114. In other words, the partitions which define bubble generating chambers 104 are constituted of the first substrate 114. The upper and lower wall surfaces of the bubble generating chamber 104 are constituted of the second substrate 116 and the nozzle plate 112, respectively. Each of the bubble generating chambers 104 has an opening 104a on the side of the common flow channel 110, and the common flow channel 110 and the bubble generating chambers 104 are connected by means of the respective openings 104a (see FIG. 3B).

The common flow channel 110 is a region where ink to be supplied to the bubble generation chambers 104 is stored, and the common flow channel 110 is formed along the row of ejection elements (the common flow channel 110 is formed in parallel with the row of ejection elements). A rectangular-shaped through hole 118 having a long and thin shape is formed in the second substrate 116. The long side of the rectangle of the through hole 118 is parallel with the row of ejection elements, and the common flow channel 110 is connected through the through hole 118 to the sub tank 202 formed inside the sub tank unit 200. The through hole 118 is formed in a rectangular elongated shape having substantially the same length and width as the common flow channel 110, and it functions as a portion of the common flow channel 110. In other words, the sub tank 202 and the common flow channel 110 (including the through hole 118) functions as a single unified flow channel structure.

The heaters 106 provided respectively so as to correspond to the bubble generating chambers 104, are formed in positions which oppose the nozzles 102 of the bubble generating chambers 104 (the heaters 106 are formed over the corresponding nozzles 102 as shown in FIG. 3A). In other words, the heaters 106 are formed on the second substrate 116 in positions corresponding to the respective bubble generating chambers 104, in such a manner that the heaters 106 oppose to the first substrate 114 (in other words, the heaters 106 are arranged on the side of the second substrate 116 adjacent to the bubble generating chambers 104). The ink inside the bubble generating chambers 104 is ejected in the form of droplets from the nozzles 102, due to the thermal energy (ejection energy) generated by the heaters 106. In other words, the ink in the bubble generating chambers 104 is heated by the heaters 106 to generate ejection bubbles so that the ink is ejected from the nozzles 102 in the form of droplets.

Bubble restricting members 120 are positioned equidistantly between the common flow channel 110 and the openings 104a that are provided on the side of the bubble generating chambers 104 adjacent to the common flow channel 110. The bubble restricting members 120 are aligned in the direction in which the ejection elements 108 are aligned (the lengthwise direction of the head). The bubble restricting members 120 are formed in a column shape which connects the bottom face (nozzle plate 112) with the ceiling face (the second substrate 116). The distance (interval) L between the bubble restricting members 120 is equal to or less than the opening width D1 of the opening 104a that is provided on the side of the bubble generating chamber 104 adjacent to the common flow channel 110, and more desirably, it is equal to or less than the nozzle diameter D2. By disposing these bubble restricting members 120 between the bubble generating chambers 104 and the common flow channel 110, it is possible to prevent bubbles of a prescribed size or larger inside the common flow channel 110 from entering the bubble generating chambers 104, and therefore, during the initial filling of ink, large bubbles are likely to be present in the common flow channel 110 and the sub tank 202, and small bubbles are likely to be present in the bubble generating chambers 104. The bubble restricting members 120 are not limited to a planar shape such as that shown in FIG. 3, and they may have a circular rod shape, an elliptical rod shape, or a polygonal rod shape, or the like.

A sub tank unit 200 is disposed on the rear surface side of the recording head 100 (in other words, the sub tank unit 200 is arranged across the second substrate 116 from the nozzle face 100A), and a sub tank 202 is provided inside the sub tank unit 200. The sub tank 202 is a liquid storage unit which stores ink to be supplied to the recording head 100 (common flow channel 110), and as described above, the sub tank 202 is connected to the common flow channel 110 via the through hole 118, thereby forming a single unified flow channel structure. Moreover, a refilling port 204 is formed at one end of the sub tank 202, and ink refilling is carried out from the main tank 300 (see FIG. 4) to the sub tank 202, through the refilling port 204.

Moreover, an air connection channel 208 which is connected to the sub tank 202 through a gas-liquid separating member 206 is provided above the sub tank 202 in the vertical direction. In the recording head 100 according to the present embodiment, the ink ejection direction is the vertical downward direction. The gas-liquid separating member 206 has a function of inhibiting the passage of liquid, such as ink, while allowing only gas, such as air, to pass. The gas-liquid separating member 206 is made of a porous member, for example. A suction port 210 is formed at one end of the air connection channel 208, and a suction pump (not shown in FIG. 3) is connected to this suction port 210. When this suction pump is operated to set the air connection channel 208 to a reduced pressure state, then the space above the ink surface in the sub tank 202 is also set to a reduced pressure state through the gas-liquid separating member 206 since gas (air) is able to pass through the gas-liquid separating member 206. In this case, the reverse flow of ink from the sub tank 202 to the air connection channel 208 is prevented by the gas-liquid separating member 206 which is disposed between the sub tank 202 and the air connection channel 208. Consequently, the ink in the sub tank 202 and the common flow channel 110 is deaerated by the pressure reduction, and the large bubbles present in the ink are removed efficiently without wasting the ink. In the present embodiment, since the sub tank 202 and the common flow channel 110 (including the through hole 118) form a single flow channel structure, then the ink in both the sub tank 202 and the common flow channel 110 is deaerated when the pressure is reduced in the space above the ink surface in the sub tank 202.

FIG. 4 is a schematic drawing showing the configuration of the ink supply system in the inkjet recording apparatus 10. As shown in FIG. 4, the main tank 300 is a base tank which supplies ink to the sub tank 202, and is disposed at the standby position described above with reference to FIG. 2. When the remaining amount of ink in the sub tank 202 has become small as the recording operation advances, then the sub tank 202 is moved to the standby position together with the recording head 100, due to the movement of the carriage 52, and ink is refilled into the sub tank 202 from the main tank 300, via the refilling port (not shown in FIG. 4 and indicated by reference numeral 204 in FIG. 3A). The main tank 300 in FIG. 4 is equivalent to the ink storing and loading unit 14 described above with reference to FIG. 1.

A filter 302 may be provided between the main tank 300 and the sub tank 202 in order to remove foreign material and bubbles. Desirably, the filter mesh size is the same as the nozzle diameter, or smaller than the nozzle diameter (generally, about 20 μm).

Furthermore, the inkjet recording apparatus 10 is also provided with a cap 304 as a device to prevent the ink from drying out or to prevent an increase in the ink viscosity in the vicinity of the nozzles, and a cleaning blade 306 as a device to clean the nozzle face 100A of the recording head 100. A maintenance unit including this cap 304 and cleaning blade 306 is disposed in the standby position described above, and is movable relatively with respect to the recording head 100 by means of a movement mechanism (not illustrated), being moved from the prescribed withdrawal position to the standby position as and when necessary.

The cap 304 is displaced up and down relatively with respect to the recording head 100 by an elevator mechanism (not shown). When the power is turned OFF or when in a print standby state, the cap 304 is raised to a predetermined elevated position so as to come into close contact with the recording head 100, and the nozzle face 100A is thereby covered with the cap 304.

The cleaning blade 306 is composed of rubber or another elastic member, and can slide on the nozzle face 100A of the recording head 100 by means of a blade movement mechanism (not shown). If ink droplets or foreign matter are adhering to the nozzle face 100A, then a so-called wiping operation is carried out in which the cleaning blade 306 wipes away the ink droplets, and the like, by wiping over the nozzle face 100A.

During printing or standby, when the frequency of use of specific nozzles is reduced and ink viscosity increases in the vicinity of those nozzles, a preliminary discharge is carried out to eject the degraded ink toward the cap 304.

Furthermore, when bubbles have become intermixed into the ink inside the recording head 100 (inside the bubble generating chambers 104), the cap 304 is placed on the recording head 100, ink (ink in which bubbles have become intermixed) inside the recording head 100 is removed by suction with a suction pump 307, and the ink removed by suction is sent to a recovery tank 308. This suction operation is also carried out in order to remove degraded ink having increased viscosity (hardened ink), when ink is loaded into the head for the first time, or when the recording head 100 starts to be used after having been out of use for a long period of time. The bubble removal method used when initially filling ink into the recording head 100 is described hereinafter.

When a state in which ink is not ejected from the recording head 100 continues for a certain amount of time or longer, the ink solvent in the vicinity of the nozzles evaporates and ink viscosity increases. In such a state, ink can no longer be ejected from the nozzle 102 even when the actuator (heater 106) for the ejection driving is operated. Before reaching such a state (in a viscosity range that allows ejection by the operation of the actuator) the actuator is operated to perform the preliminary discharge to eject the ink whose viscosity has increased in the vicinity of the nozzle toward the ink receptor. After the nozzle face 100A is cleaned by a wiper such as the cleaning blade 306 provided as the cleaning device for the nozzle face 100A, a preliminary discharge is also carried out in order to prevent the foreign matter from becoming mixed inside the nozzles by the wiper sliding operation (wiping operation). The preliminary discharge is also referred to as “dummy discharge”, “purge”, “liquid discharge”, and so on.

When bubbles have become intermixed in the nozzle 102 or the bubble generation chamber 104, or when the ink viscosity in the vicinity of the nozzle has increased over a certain level, ink can no longer be ejected by the preliminary discharge, and a suctioning action is carried out as follows.

More specifically, when bubbles have become intermixed in the ink inside the nozzle 102 and the bubble generation chamber 104, or when the ink viscosity in the vicinity of the nozzle has increased to a certain level or more, ink can no longer be ejected from the nozzle 102 even if the actuator is operated. In these cases, a cap 304 serving as a suctioning device to remove the ink inside the bubble generation chamber 104 by suction with a suction pump, or the like, is placed on the nozzle face 100A of the recording head 100, and the ink in which bubbles have become intermixed or the ink whose viscosity has increased is removed by suction.

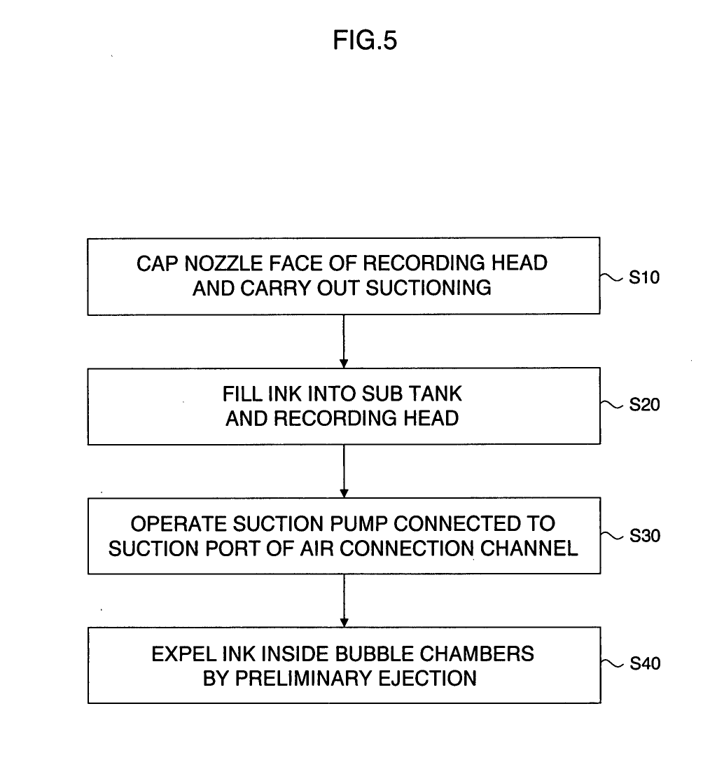

Next, a bubble removal method during initial refilling of ink into the recording head 100 will now be described. FIG. 5 is a flow diagram showing a bubble removal method during initial filling.

Firstly, after moving the recording head 100 to a prescribed standby position (see FIG. 2), the nozzle face 100A of the recording head 100 is capped and suctioning is carried out (step S10). More specifically, the cap 304 is abutted against the nozzle face 100A and the suction pump 307 connected to the cap 304 is operated. By this means, the interior of the recording head 100 is set to a reduced pressure state.

In the reduced pressure state of this kind, ink is filled into the sub tank 202 and the recording head 100 from the main tank 300 (step S20), and ink flows into the sub tank 202 and the recording head 100. In this case, the ink does not flow uniformly as a single pool of liquid, and the air originally present inside the sub tank 202 and the recording head 100 is also carried together with the ink in the form of bubbles. The bubbles that occur in the ink have various size (there exist large bubbles and small bubbles). Since the large bubbles are trapped by the bubble restricting members 120 when the ink in the common flow channel 110 passes through the bubble restricting members 120, then only the small bubbles flow into the bubble generating chambers 104. Consequently, large bubbles are likely to be present in the sub tank 202 and the common flow channel 110, whereas small bubbles are likely to be present in the bubble generating chambers 104.

Next, the suction pump 310 (see FIG. 4) connected to the suction port 210 of the air connection channel 208 is operated, and the air connection channel 208 is set to a reduced pressure state (step S30). Consequently, the space above the ink surface in the sub tank 202 is set to a reduced pressure state via the gas-liquid separating member 206, the ink in the sub tank 202 and the common flow channel 110 is deaerated, and the large bubbles present in the ink can be removed efficiently without giving rise to wasted consumption of ink (without wasting the ink). In this case, the reverse flow of ink from the sub tank 202 to the air connection channel 208 is prevented by the gas-liquid separating member 206 which is disposed between the sub tank 202 and the air connection channel 208.

Finally, the bubbles are expelled to the exterior of the head, together with the ink inside the bubble generating chambers 104, by means of preliminary ejection (purging) (step S40). Since the bubbles present in the common flow channel 110 and the sub tank 202 have already been removed by deaeration through pressure reduction, then it is sufficient to carry out preliminary ejection a prescribed number of times in order to remove the ink inside the bubble generating chambers 104. Since the capacity of the bubble generating chambers 104 is markedly smaller than the capacity of the common flow channel 110 and the sub tank 202, it is therefore possible to minimize the wasteful consumption of ink.

In the present embodiment, as shown in FIG. 3B, by setting the distance (interval) L between the bubble restricting members 120 to be smaller than the opening width D1 of the opening 104a of the bubble generating chamber 104 (in other words, L<D1), and more desirably, to be smaller than the nozzle diameter D2 (in other words, L<D2), then bubbles of smaller size become present in the bubble generating chambers 104, and the amount of ink consumed wastefully during preliminary ejection or suctioning can be reduced yet further, while at the same time it is possible to remove the bubbles reliably and efficiently.

In the case where the condition of L<D2 is not satisfied, there is a high probability that it will become difficult to remove bubbles (which have relatively large size) by means of preliminary ejection. In such a case, the bubbles can be removed by suctioning with a cap, but the amount of ink expelled is considerable in the case of suctioning with a cap, compared to preliminary ejection. Hence, the condition of L<D2 is preferably satisfied, since it is possible to remove bubbles by means of preliminary ejection without carrying out suctioning with a cap, and the bubbles can be removed efficiently (in other words, involving little consumption of ink).

As described above, during initial filling of ink into the recording head 100, for example, it is possible to sort the bubbles occurring in the ink inside the head according to the size of the bubbles by means of the bubble restricting members 120 which are disposed between the bubble generating chambers 104 and the common flow channel 110. In this way, large bubbles will be present in the sub tank 202 or the common flow channel 110, whereas small bubbles will be present in the bubble generating chambers 104. Therefore, by reducing the pressure in the air connection channel 208 which is connected to the sub tank 202 via the gas-liquid separating member 206, the pressure in the space above the ink surface in the sub tank 202 is also reduced, and the ink in the sub tank 202 and the common flow channel 110 can be deaerated, thereby enabling the large bubbles present in the sub tank 202 or the common flow channel 110 to be removed without creating wasteful consumption of ink. On the other hand, by expelling the ink inside the bubble generating chambers 104 to the exterior of the head by means of preliminary ejection or suctioning, it is possible to remove small bubbles which are present in the bubble generating chambers 104. Consequently, it is possible to remove bubbles efficiently while minimizing wasteful consumption of ink.

In implementing the present invention, the ejection method is not limited to a thermal method which performs ejection by using heat generating elements, such as heaters, as in the present embodiment, and it is also possible to adopt a piezoelectric method which performs ejection by using piezoelectric elements, or other types of ejection methods.

The liquid supply apparatus, the liquid supply method and the image forming apparatus according to the present invention have been described in detail above, but the present invention is not limited to the aforementioned embodiments, and it is of course possible for improvements or modifications of various kinds to be implemented, within a range which does not deviate from the essence of the present invention.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid supply apparatus, comprising:
a liquid ejection head which includes: a plurality of bubble generating chambers in which liquid is heated to generate ejection bubbles causing the liquid to be ejected through ejection ports; a common flow channel connected to the plurality of bubble generating chambers and storing the liquid to be supplied to the plurality of bubble generating chambers; and bubble restricting members restricting passage of bubbles between the common flow channel and the plurality of bubble generating chambers;
a liquid storage unit which is connected to the common flow channel and which stores the liquid to be supplied to the common flow channel;
a first suctioning device which caps and suctions an ejection face of the liquid ejection head on which the ejection ports are arranged; and
a pressure reduction device which reduces pressure of the liquid storage unit.

2. The liquid supply apparatus as defined in claim 1, wherein the pressure reduction device comprises:
an air connection channel which is connected through a gas-liquid separating member to the liquid storage unit, the gas-separating member inhibiting passage of the liquid while allowing passage of gas; and
a second suctioning device which is connected to the air connection channel and suctions gas in the air connection channel.

3. The liquid supply apparatus as defined in claim 1, wherein an interval between the bubble restricting members is less than a diameter of the ejection ports.

4. A liquid supply method for a liquid ejection apparatus which includes: a liquid ejection head having a plurality of bubble generating chambers in which liquid is heated to generate ejection bubbles causing the liquid to be ejected through ejection ports, a common flow channel which is connected to the plurality of bubble generating chambers and which stores the liquid to be supplied to the plurality of bubble generating chambers, and bubble restricting members restricting passage of bubbles between the common flow channel and the plurality of bubble generating chambers; a liquid storage unit which is connected to the common flow channel and which stores the liquid to be supplied to the common flow channel; a suctioning device which caps and suctions an ejection face of the liquid ejection head on which the ejection ports are arranged; and a pressure reduction device which reduces pressure of the liquid storage unit, the liquid supply method comprising the steps of:
capping and suctioning the ejection face of the liquid ejection head;
supplying the liquid to the liquid storage unit;
reducing the pressure of the liquid storage unit; and
performing preliminary ejection of the liquid in the bubble generating chambers.

5. An image forming apparatus comprising the liquid supply apparatus as defined in claim 1.
